(19) United States
(12) Patent Application Publication
(10) Pub. No.: US 2010/0174850 A1
(43) Pub. Date: Jul. 8, 2010

(54) DATA MOVING METHOD AND SYSTEM UTILIZING THE SAME

(76) Inventors: Chin-Huo Chu, Kao-Hsiung Hsien (TW); Yi-Hsiang Lin, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/350,229

(22) Filed: Jan. 8, 2009

(51) Int. Cl. G06F 13/00

(52) U.S. Cl. 711/103; 711/E12.002

(57) ABSTRACT

A data moving method includes: detecting if data to be written from at least first source data unit of a storage unit includes a specific pattern or not; and simplifying writing operation while writing the data from a second source data unit to a first target data unit if the data includes a specific pattern, wherein the second source data unit includes at least one first source data unit, and the first target data unit includes at least one second target data unit.

### BACKGROUND OF THE INVENTION

1. Field of the Invention

The present invention discloses a data moving method and a system utilizing the method, and particularly relates to a data moving method that can save unnecessary writing steps and a system utilizing the method.

2. Description of the Prior Art

FIG. 1 is a block diagram illustrating related art copy operation for a NAND flash. As shown in FIG. 1, data is copied from a source block 101 of a NAND flash, and the source block 101 includes a plurality of source pages 103, 105 and 107. It should be noted that only part of the source pages are illustrated. Also, the whole target block 109 is erased and the copied data from the source block 101 are written into the target block 109. However, some pages of the source block 101, such as the source pages 105 and 107 include only blank data (pattern 0xff in this case), thus corresponding target pages, such as the target pages 113 and 115, will only include blank data after copy operation, too.

As known by persons skilled in the art, the blank data means that the page is empty. Accordingly, the copy and writing operation of blank data is un-meaningful and unnecessary, and wastes time and much system resource. Similarly, if target block 109 includes some pages originally having the same patterns as the corresponding pages in the source block 101 before the copy and writing operation, the copy and writing operations of these patterns are also unnecessary and waste system source.

### SUMMARY OF THE INVENTION

One embodiment of the present invention provides a data moving method, comprising: detecting if data to be written from a source data unit of a storage unit includes a specific pattern or not; and simplifying writing operation while writing the data to be written to a target data unit if the data to be written includes the specific pattern.

Another embodiment of the present invention provides a data moving method, comprising: detecting if data to be written from at least source data unit of a storage unit includes a specific pattern or not; and simplifying writing operation while writing the data from a source data block to a target data block if the data includes a specific pattern, wherein the source data block includes at least one source data unit, and the target data block includes at least one target data unit.

Another embodiment of the present invention discloses a data moving system, comprising: a pattern detector, for detecting if data to be written from a source data unit of a storage unit includes a specific pattern or not; and a processor, for simplifying writing operation while writing the data to be written to a target data unit if the data to be written includes the specific pattern.

According to above-mentioned embodiments, unnecessary writing operation can be avoided such that the accessing speed can increase and the consuming of system resource can decrease.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating related art copy operation for a NAND flash.

FIG. 2 is a flow chart illustrating a data moving method according one embodiment of the present invention.

FIG. 3a is a schematic diagram illustrating the “omitting” operation of a data moving method according one embodiment of the present invention.

FIG. 3b is a schematic diagram illustrating the operation of a data moving method according one embodiment of the present invention.

FIG. 4 is a flow chart illustrating a data moving method according one embodiment of the present invention.

FIG. 5 is a flow chart illustrating one example of detail steps of the embodiment shown in FIG. 4.

FIG. 6 is a flow chart illustrating another example of detail steps of the embodiment shown in FIG. 4.

FIG. 7 is a schematic diagram illustrating the application of the data moving methods according to embodiments of the present invention.

FIG. 8 is a block diagram illustrating a flash controller utilizing above mentioned data moving methods.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

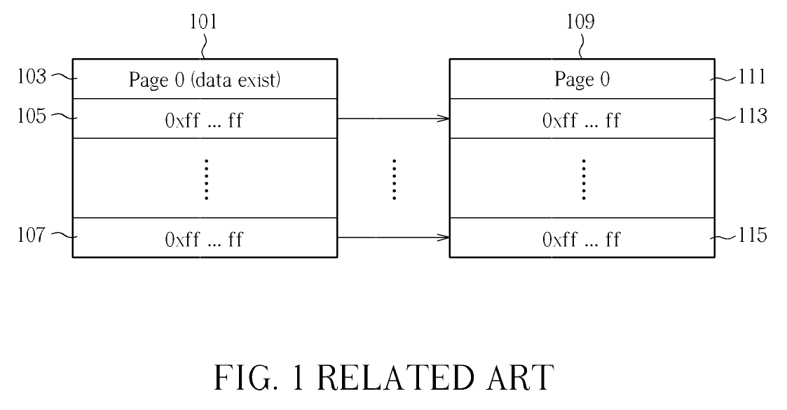

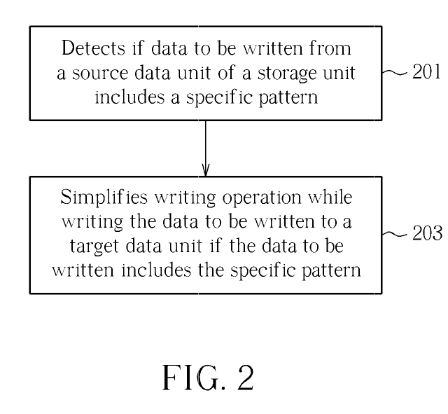

FIG. 2 is a flow chart illustrating a data moving method according one embodiment of the present invention. As shown in FIG. 2, the data moving method includes steps 201 and 203. Step 201 detects if data to be written from a source data unit (ex. the source block 101 in FIG. 1) of a storage unit includes a specific pattern. Step 203 simplifies writing operation while writing the data to be written to a target data unit (ex. target page 113) if the data to be written includes the specific pattern.

The specific pattern can be any pattern, and the meaning of simplifying the writing operation can be varied accordingly. Take FIG. 1 for example, the specific pattern is 0xff, and the meaning of simplifying the writing operation indicates that “do not write the data from the source data unit to the target data unit”, because blank data needs no copy operation.

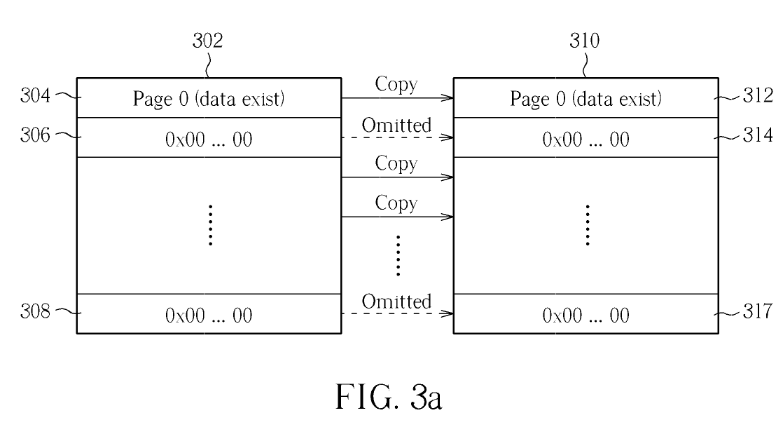

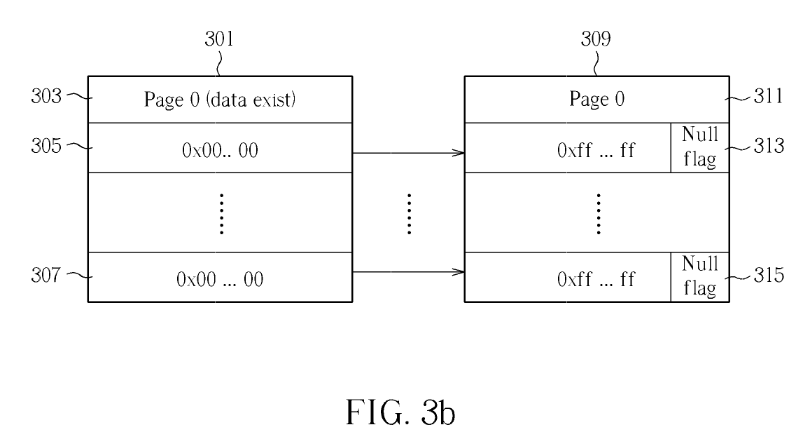

FIG. 3a is a schematic diagram illustrating the omitting operation of a data moving method according one embodiment of the present invention. As shown in FIG. 3a, a source page 304 in the source block 302 includes real data, and the other non-illustrated source pages also include real data. The source pages 306 and 308 include blank data, however. Therefore, when the data in the source block 302 is copied to the target block 310, the data in the source page 304 is also copied to a corresponding target page 312. The data in the non-illustrated source pages are also copied to corresponding target pages. However, the copy and writing operations from the source pages 306 and 308 to corresponding target pages 314 and 317 are omitted. By this way, the copy and writing operation between the source block 302 and the target block 310 can speed up and system source can be saved.

FIG. 3b is a schematic diagram illustrating the operation of a data moving method according one embodiment of the present invention. The specific pattern in the source page 305, 307 can be other patterns indicating blank data, such as 0x00. The corresponding target pages 313 and 315 are supposed to be empty and utilize 0xff to indicate blank data. In this case, the meaning of simplifying the writing operation indicates that “mark the target page (for example, adding a null flag)”.

Please note that although a NAND flash is utilized to explain the embodiment shown in FIG. 2, the data moving method according to the embodiment of the present invention can also be utilized to other memories such as NOR flash. NOR flash can randomly access data via various types of data units thereof. Therefore the source data unit and the target data unit can be other data units besides pages.

Please note that the page sizes are different in different types of flash, may be 4 KB (Kbytes), 2 KB, or 512 B (bytes). When page size is 2 KB, one page may contain 4 sectors, each sector size is 512 B. In another embodiment, the data unit is a sector, a smaller unit than a page.

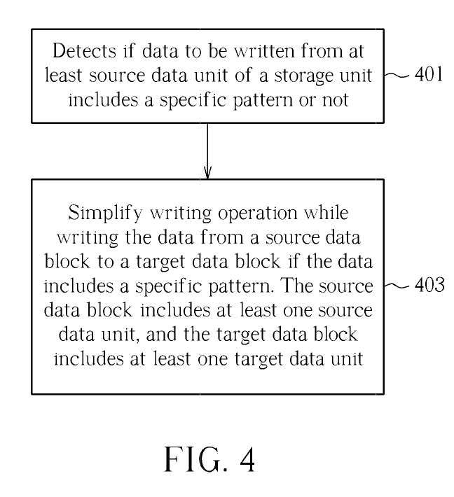

FIG. 4 is a flow chart illustrating a data moving method according one embodiment of the present invention. As shown in FIG. 4, the data moving method includes steps 401 and 403. Step 401 detects if data to be written from at least source data unit of a storage unit (ex. a NAND flash) includes a specific pattern or not. Step 403 simplifies writing operation while writing the data from a source data block to a target data block if the data includes a specific pattern. The source data block includes at least one source data unit, and the target data block includes at least one target data unit.

The step of simplifying the writing operation can include: writing no data from the first source data unit to the second target data unit. The step of simplifying the writing operation can further include: marking the second target data unit.

Take the NAND flash shown in FIG. 1 for example. The data moving method according one embodiment of the present invention detects if the source page 105, 107 (first source data unit) includes specific pattern or not while copying data from the source block 101 (second source data unit) to the target block 109 (first target data unit). Comparing with embodiments shown in FIG. 2 and FIG. 4, the embodiment shown in FIG. 2 checks if a small data unit (ex. a page or a sector) has specific patterns or not when copy the data in a small data unit to another small data unit, but the embodiment shown in FIG. 4 checks if a small data unit (ex. a page or a sector) has specific patterns or not when copy the data in a large data unit (ex. a block or a page) to another large data unit.

The step of simplifying the writing operation can include: writing no data from the target pages 105, 107 to the target pages 113, 115 (the second target data unit). Alternatively, the step of simplifying the writing operation can further include: marking the target pages 113, 115. For example, adding null flags as shown in FIG. 3.

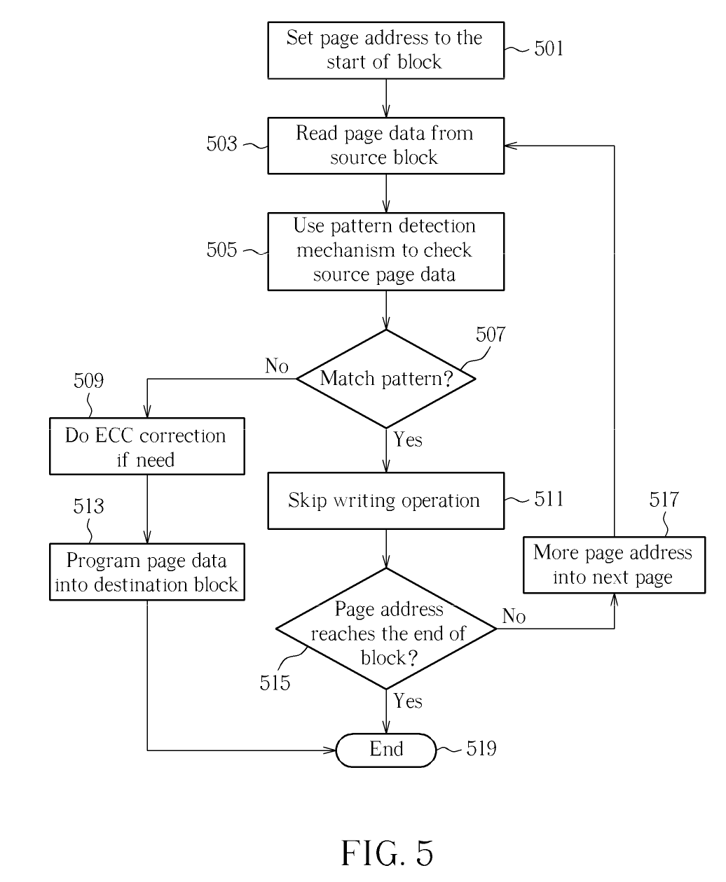

FIG. 5 is a flow chart illustrating one example of detail steps of the embodiment shown in FIG. 4. Please note that the detail steps are only for example and do not mean to limit the scope of the present invention. The steps shown in FIG. 5 includes steps 501˜519. Step 501 sets page address to the start of block. Step 503 reads page data (ex. data in the source pages 105 and 107) from source block (ex. 101). Step 505 utilizes pattern detection mechanism to check source page data, that is, detect if source page data includes a specific pattern.

Step 507 determines if source page data includes a specific pattern, if yes go to step 511, if not go to step 509. Step 509 performs ECC correction. Since some types of memories need ECC correction but some types do not need, the step 509 can be omitted. Step 511 skips writing operation, that is, does not copy data having specific pattern to corresponding target pages. Step 513 programs page data into destination block, that is, copy data in the source pages to the target pages. Step 515 determines if page address reaches the end of the block, if yes go to step 517, if not, go to step 519 and ends. Step 517 moves page address into next page and goes back to the step 503.

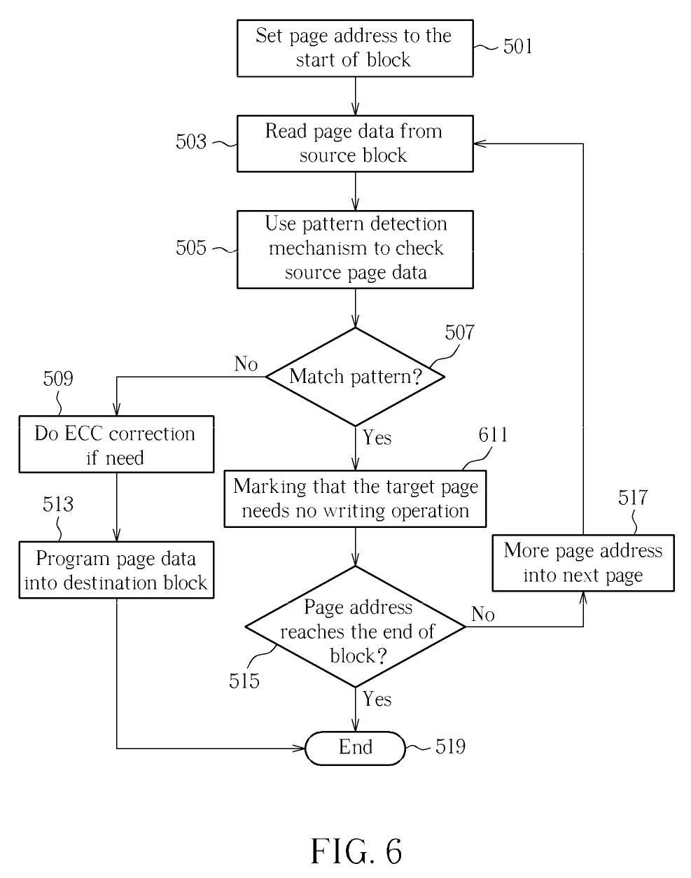

FIG. 6 is a flow chart illustrating another example of detail steps of the embodiment shown in FIG. 4. Comparing with the steps shown in FIG. 5 and FIG. 6, Step 511 is replaced with step 611. Step 511 skips writing operation, but step 611 marks that the target pages (for example, add a null flag as shown in FIG. 3).

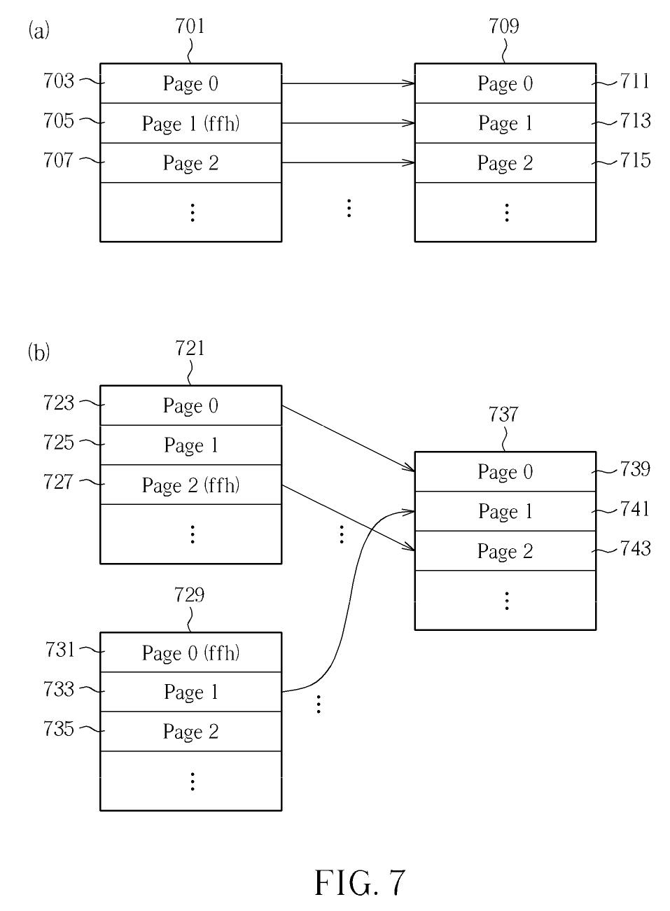

FIG. 7 is a schematic diagram illustrating the application of the data moving methods according to embodiments of the present invention, it is only for example and does not mean to limit the scope of the present invention. FIG. 7(a) is a schematic diagram illustrating an operation called wear-leveling, which indicates move cold data in a source block 701 to a target block 703 that is frequently accessed, such that the blocks can be average accessed. Cold data means that the accessing numbers of data are less than other data. Since the number of accessing for blocks are limited, such mechanism can prevent blocks from broken. In this case, block copy operation is necessary thus the data moving method according to embodiments of the present invention can be applied to such operation. Since the wear-leveling operation is well-known by persons skilled in the art, it is omitted for brevity here.

FIG. 7(b) is a schematic diagram illustrating an operation called block merge, which indicates that a logical block address (LBA) corresponds to more than one physical blocks 705 and 707. In this case, the storage space is wasted, if unnecessary data are stored in pages of the physical blocks, such as pages 709 and 711. Therefore, the unnecessary data can be removed and other data can be copied from the physical blocks 705 and 707 to the target block 713, and the storage space of the physical blocks 705 and 707 can be saved by this way. Thereby the block copy operation is necessary thus the data moving method according to embodiments of the present invention can be applied to such operation. Since the block merge operation is well-known by persons skilled in the art, it is omitted for brevity here.

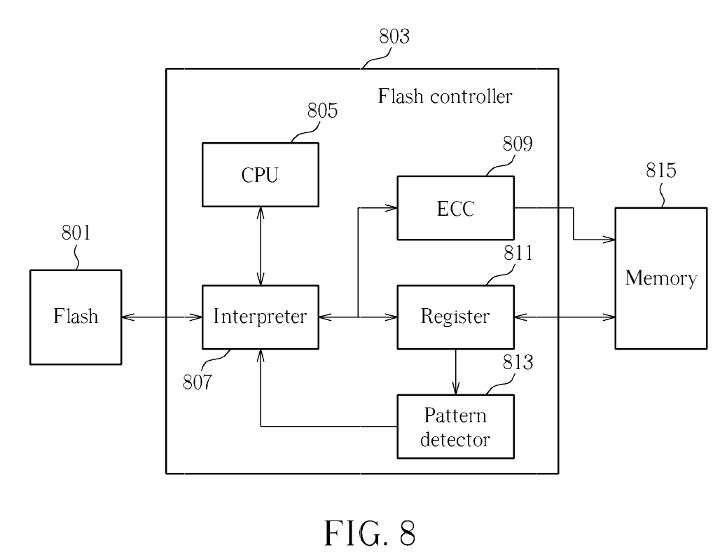

FIG. 8 is a block diagram illustrating a flash controller utilizing above mentioned data moving methods. However, please note that the above mentioned data moving methods are not limited to be applied to the flash controller shown in FIG. 8, the numbers and locations of the devices shown in FIG. 8 do not mean to limit the scope of the present invention. As shown in FIG. 8, a flash controller 803 is utilized to control the flash 801. The flash controller 803 includes a CPU 805, an interpreter 807, an ECC block 809, a register 811, a pattern detector 813. The CPU 805 serves to control the operation of the devices in the flash controller 803. The interpreter 807 is served as an interface for communicating the devices in the flash controller 803 and the flash 801. The ECC (error correction code) block 809 serves to perform ECC operation to data to be written, and then the data after ECC is saved to the memory 815. The register 811 serves to register the data needs ECC. The pattern detector 813 is utilized to detect if the data to be written has specific pattern.

According to above mentioned description, if the pattern detector 813 detects that the data includes specific data. The writing operation is simplified. Alternatively, the data is performed ECC operation by the ECC block, if necessary. After that, the data after ECC is stored to the memory 815.

According to above-mentioned embodiments, unnecessary writing operation can be avoided such that the accessing speed can increase and the consuming of system resource can decrease.

Those skilled in the art will readily observe that numerous modifications and alterations of the device and method may be made while retaining the teachings of the invention.

What is claimed is:

1. A data moving method, comprising:
detecting if data to be written from a source data unit of a storage unit includes a specific pattern or not; and
simplifying writing operation while writing the data to be written to a target data unit if the data to be written includes the specific pattern.

2. The data moving method of claim 1, wherein the storage unit is a NAND flash, and the source data unit and the target data unit are pages or sectors.

3. The data moving method of claim 1, wherein the storage unit is a NOR flash.

4. The data moving method of claim 1, wherein the specific pattern is a pattern indicating blank data.

5. The data moving method of claim 1, wherein the step of simplifying the writing operation includes:
writing non of the data to be written to the target data unit.

6. The data moving method of claim 5, wherein the step of simplifying the writing operation further includes:
marking the target data unit.

7. A data moving method, comprising:
detecting if data to be written from at least source data unit of a storage unit includes a specific pattern or not; and
simplifying writing operation while writing the data from a source data block to a target data block if the data includes a specific pattern, wherein the source data block includes at least one source data unit, and the target data block includes at least one target data unit.

8. The data moving method of claim 7, wherein the storage unit is a NAND flash, and the source data unit and the target data unit are pages or sectors.

9. The data moving method of claim 7, wherein the storage unit is a NOR flash.

10. The data moving method of claim 7, wherein the specific pattern is a pattern indicating blank data.

11. The data moving method of claim 7, wherein the step of simplifying the writing operation includes:
writing non of the data from the first source data unit to the second target data unit.

12. The data moving method of claim 11, wherein the step of simplifying the writing operation further includes:
marking the target data unit.

13. A data moving system, comprising:
a pattern detector, for detecting if data to be written from a source data unit of a storage unit includes a specific pattern or not; and
a processor, for simplifying writing operation while writing the data to be written to a target data unit if the data to be written includes the specific pattern.

14. The data moving system of claim 13, wherein the storage unit is a NAND flash, and the source data unit and the target data unit are pages or sectors.

15. The data moving system of claim 13, wherein the storage unit is a NOR flash.

16. The data moving system of claim 13, wherein the specific pattern is a pattern indicating blank data.

17. The data moving system of claim 13, wherein the processor simplifies the writing operation via: writing non of the data to be written to the target data unit.

18. The data moving system of claim 17, wherein the processor simplifies the writing operation via:
marking the target data unit that the target data unit.
